(19) United States
(12) Patent Application Publication
(10) Pub. No.: US 2016/0175995 A1
(43) Pub. Date: Jun. 23, 2016

(54) FIXTURE FOR WELDING FABRICATION OF A GOLF CLUB HEAD

(71) Applicant: METAL INDUSTRIES RESEARCH & DEVELOPMENT CENTRE, Kaohsiung City (TW)

(72) Inventors: Yeh-Min Lin, Kaohsiung City (TW); Chih-Chung Lin, Kaohsiung City (TW); Ming-Yeuh Tsai, Kaohsiung City (TW); Cheng-Yen Chen, Kaohsiung City (TW); Ho-Chung Fu, Kaohsiung City (TW)

(21) Appl. No.: 14/576,282

(22) Filed: Dec. 19, 2014

(51) Int. Cl. B23K 37/04

(52) U.S. Cl. CPC B23K 37/0435

(57) ABSTRACT

A fixture for welding fabrication of a golf club head features a golf club head's hitting surface facing up and placed on a platform for a welding process so that a reverse side opposite to the welded hitting surface of the golf club head is held in a

V-shaped groove on a fifth clamping part and the golf club head's peripheral surface contacts a first clamping part and a second clamping part; the golf club head can be held among the first clamping part, the second clamping part, a third clamping part driven by a first stroke unit to move toward the first clamping part, and a fourth clamping part driven by a second stroke unit to move toward the second clamping part; the hitting surface can be welded because of the golf club head free from movement toward the reverse side, which is opposite to the welded hitting surface, by means of the fifth clamping part.

### BACKGROUND OF THE INVENTION

1. Field of the invention

The present disclosure relates to a fixture for welding a golf club head, particularly a fixture for welding fabrication of a golf club head which reduces costs of mold making, simplifies the manufacturing process, and is economical of expenditures of manufacturing golf club heads.

2. Description of the prior art

A golfer has to use golf clubs with distinct materials and structures for tee-off or putt, particularly tee-off which requires a golf club head hitting golf balls with strong power. Accordingly, specific sheet metal should be welded on the hitting surface of a golf club head in a special welding process.

Considering conditions of conventional fixtures for manufacture of golf club heads such as high manufacturing cost and low speed of clamping a golf club head, the patent applicant developed a fixture for welding fabrication of a golf club head after years of research.

### SUMMARY OF THE INVENTION

The present disclosure is to provide a fixture for welding fabrication of a golf club head which depends on a single fixture to position and weld different types of golf club heads with specific sizes.

To this end, a fixture for welding fabrication of a golf club head comprises a first fixing support, a second fixing support, a first moveable support and a second moveable support, all of which are installed on a platform: the first fixing support and the second fixing support are perpendicular to each other; the first moveable support and the first fixing support are parallel to each other; the second moveable support and the second fixing support are parallel to each other; the first fixing support comprises a first clamping part; the second fixing support comprises a second clamping part; the first moveable support comprises a first stroke unit and a third clamping part; the second moveable support comprises a second stroke unit and a fourth clamping part.

On a golf club head, a hitting surface to be welded should face up and is placed on the platform so that the peripheral surface of the golf club head contacts the first clamping part and the second clamping part. Next, the first stroke unit and the second stroke unit are used in driving the third clamping part to move toward the first clamping part and driving the fourth clamping part to move toward the second clamping part, respectively. As such, the golf club head is held among the first clamping part, the second clamping part, the third clamping part and the fourth clamping part and free from movement toward another side, which is opposite to the hitting surface being welded, by means of a fifth clamping part so that the hitting surface is welded on the golf club head.

### BRIEF DESCRIPTION OF THE DRAWINGS

FIG. 1 is a perspective view illustrating a fixture for welding fabrication of a golf club head;

FIG. 2 is a schematic view illustrating a first fixing support in a fixture for welding fabrication of a golf club head from an angle of view;

FIG. 3 is another schematic view illustrating a second fixing support in a fixture for welding fabrication of a golf club head from another angle of view;

FIG. 4 is the first schematic view which illustrates movement of a fixture for welding fabrication of a golf club head;

FIG. 5 is the second schematic view which illustrates movement of a fixture for welding fabrication of a golf club head; and

FIG. 6 is the third schematic view which illustrates movement of a fixture for welding fabrication of a golf club head.

### DETAILED DESCRIPTION OF THE PREFERRED EMBODIMENT

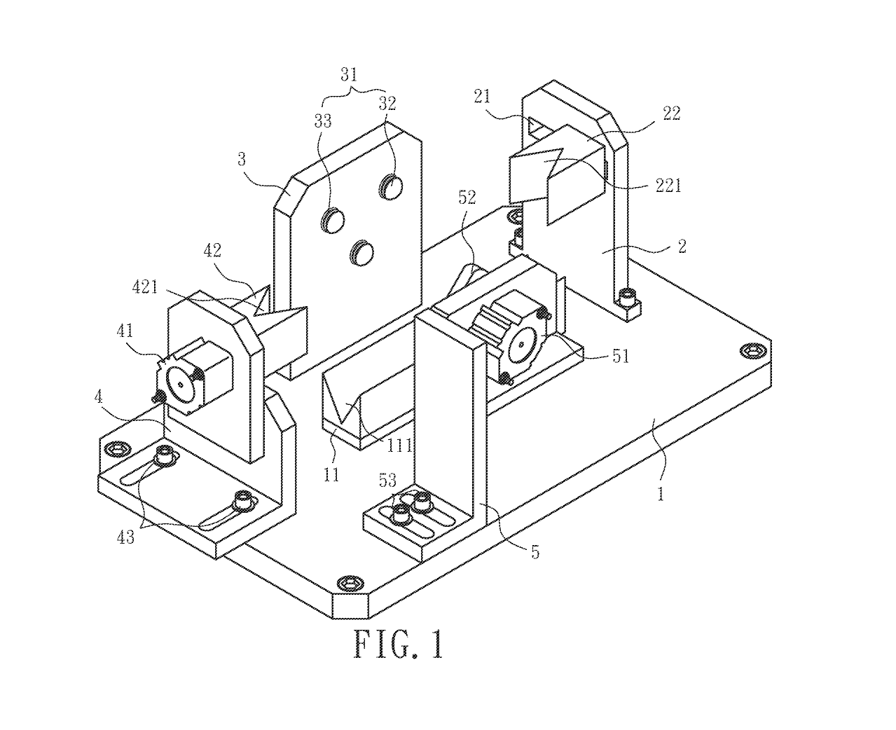

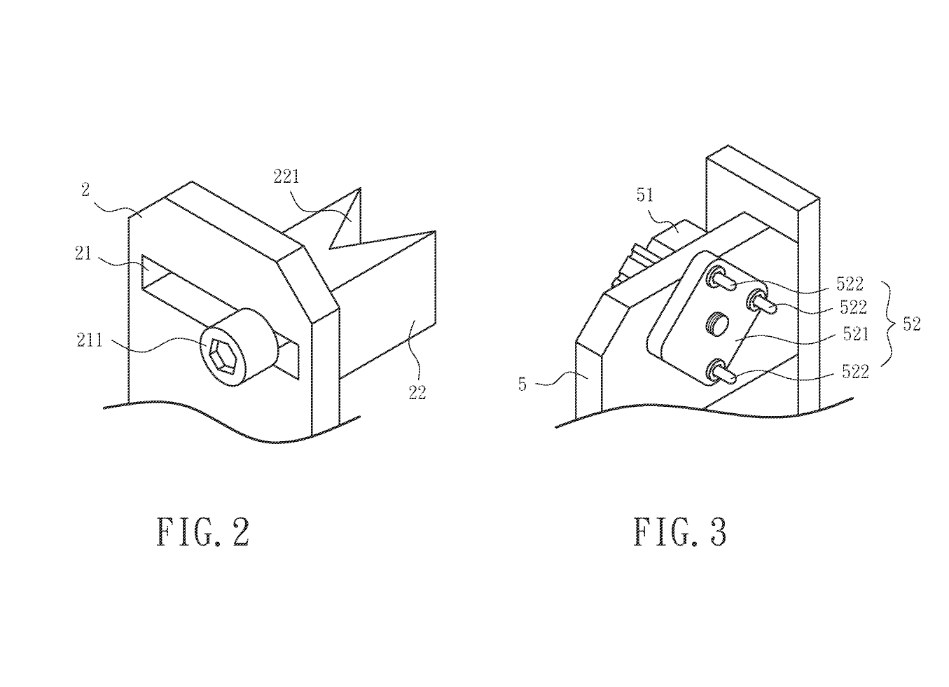

Referring to FIG. 1 through FIG. 3 which illustrate a fixture for welding fabrication of a golf club head comprises a platform 1, a first fixing support 2, a second fixing support 3, a first moveable support 4 and a second moveable support 5: the first fixing support 2, the second fixing support 3, the first moveable support 4 and the second moveable support 5 are vertically mounted on the platform 1; the first fixing support 2 comprises an adjustable structure which has a transverse displacement slot 21 and a sliding component 211 held and shifted along the displacement slot 21 and coupled with a first clamping part 22; the second fixing support 3 comprises at least a second clamping part 31 (three second clamping parts 31 forming a triangular arrangement and illustrated in the embodiment and drawings) which has a contacting part 32 and a resilient cushion 33 between the contacting part 32 and the second fixing support 3; the first moveable support 4 comprises a first stroke unit 41 and a third clamping part 42; the second moveable support 5 comprises a second stroke unit 51 and a fourth clamping part 52 which has a bottom panel 521 and three fastening parts 522, for example, screws or other lengthwise adjustable components, protruding from the bottom panel 521, adjusted in length, and forming a triangular arrangement; the first fixing support 2, the second fixing support 3, the first moveable support 4 and the second moveable support 5 on the platform 1 are centrally provided with a fifth clamping part 11 that is an elongate component on which a V-shaped groove 111 extending lengthwise is opened.

The second fixing support 3 and the first fixing support 2 are adjacent to each other; the first moveable support 4 and the first fixing support 2 are opposite to each other; the second moveable support 5 and the second fixing support 3 are opposite to each other; the first clamping part 22 is arranged on a plane of the first fixing support 2 opposite to the first moveable support 4; the third clamping part 42 is arranged on a plane of the first moveable support 4 opposite to the first fixing support 2 and corresponds to the first clamping part 22; the second clamping part 31 is arranged on a plane of the second fixing support 3 opposite to the second moveable support 5; the fourth clamping part 52 is arranged on a plane of the second moveable support 5 opposite to the second fixing support 3 and corresponds to the second clamping part 31; the first stroke unit 41 is used in driving the third clamping part 42 to move toward the first fixing support 2; the first stroke unit 41 and the third clamping part 42 are provided with a resilient cushion unit (not shown in figures) in between; the second stroke unit 51 is used in driving the fourth clamping part 52 to move toward the second fixing support 3; the first clamping part 22 and the third clamping part 42 comprises a V-shaped groove 221 and a V-shaped groove 421, respectively.

Moreover, the first moveable support 4 is provided with a first displacement structure 43 by which the first moveable support 4 is adjusted in distance between the first moveable support 4 and the first fixing support 2; the second moveable support 5 is provided with a second displacement structure 53 by which the second moveable support 5 is adjusted in distance between the second moveable support 5 and the second fixing support 2.

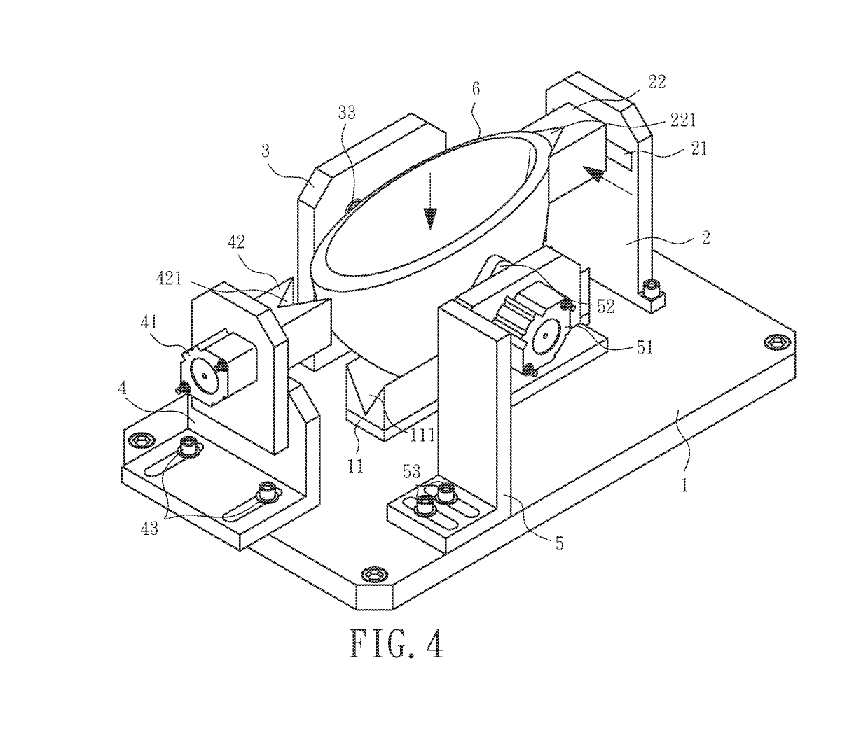

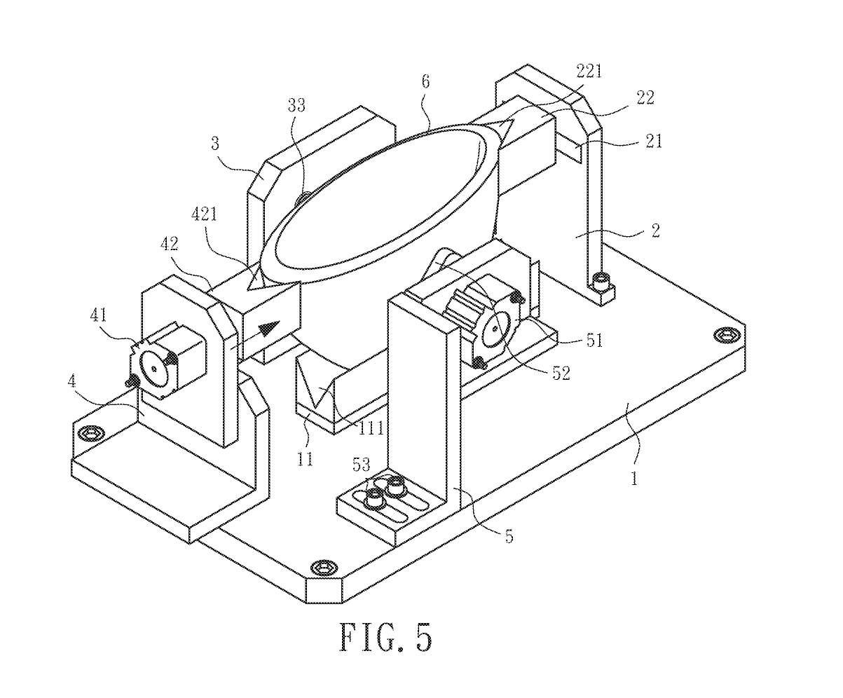

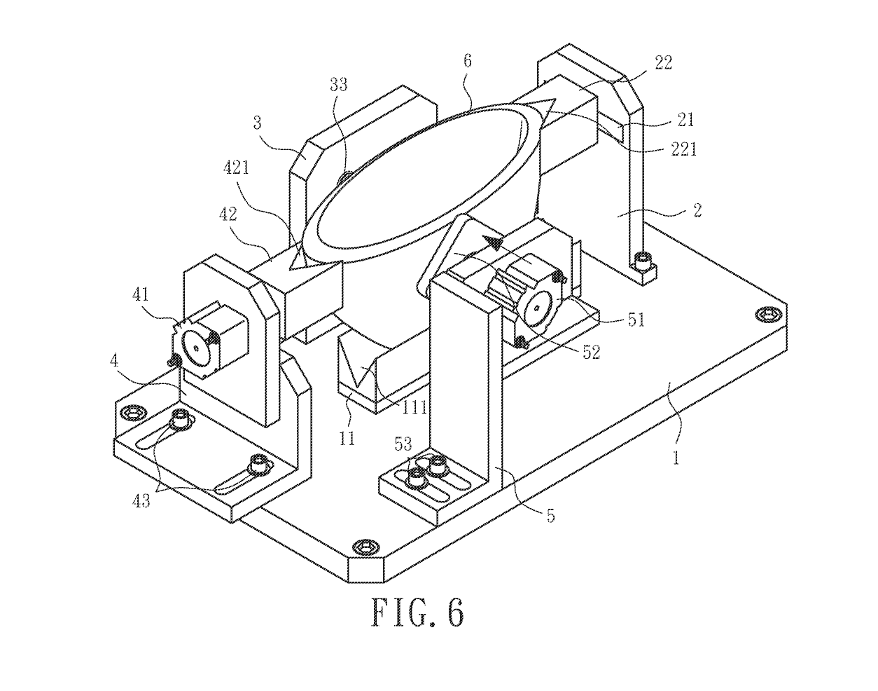

Referring to FIG. 1 through FIG. 6 which illustrate a fixture for welding fabrication of a golf club head in service. On a golf club head 6, a hitting surface to be welded should face up and a reverse side opposite to the hitting surface being welded should be inserted into the V-shaped groove 111 on the fifth clamping part 11. After the golf club head 6 is inserted into the V-shaped groove 111 on the fifth clamping part 11, one end adjacent to the first fixing support 2 should be inserted into the V-shaped groove 221 on the first clamping part 22 which can be adjusted with the displacement slot 21 on the first fixing support 2 so that the end adjacent to the first fixing support 2 is held in the V-shaped groove 221 by means of the first clamping part 22. After the golf club head 6 is inserted into the V-shaped groove 111 on the fifth clamping part 11, a peripheral surface adjacent to the second fixing support 3 should contact the second clamping parts 31.

Next, the first stroke unit 41 should drive the third clamping part 42 to move toward the first fixing support 2, allowing both opposite ends on the golf club head 6 to be held by the V-shaped groove 221 on the first clamping part 22 and the V-shaped groove 421 on the third clamping part 42; the second stroke unit 51 should drive the fourth clamping part 52 to move toward the second fixing support 3, allowing the periphery of the golf club head 6 to be securely held by the first clamping part 22, the second clamping part 31, the third clamping part 42 and the fourth clamping part 52. Moreover, the golf club head 6 simultaneously held by the first clamping part 22, the second clamping part 31, the third clamping part 42 and the fourth clamping part 52 is grasped, positioned, and not shaken along the periphery in four directions perpendicular to one another because the first fixing support 2 and the first moveable support 4 in a fixture for welding fabrication of a golf club head are perpendicular to the second fixing support 3 and the second moveable support 5, respectively. As such, a robot for automated welding of the golf club head 6 can be positioned in place. Because the reverse side opposite to the welded hitting surface on the golf club head 6 is inserted into the V-shaped groove 111 on the fifth clamping part 11, the golf club head is free from movement toward the reverse side which is opposite to the welded hitting surface, securely held in a fixture for welding fabrication of a golf club head, and easily operated without repositioning and adjusting the position of the golf club head by a welding machine operator.

Additionally, each of the V-shaped groove 111 on the fifth clamping part 11, the V-shaped groove 221 on the first clamping part 22 and the V-shaped groove 421 on the third clamping part 42 in a fixture for welding fabrication of a golf club head is designed as a component with the groove tapered outside-in which facilitates a golf club head 6 with a distinct size to be securely grasped and welded in a fixture for welding fabrication of a golf club head. When the golf club head 6 is held in a fixture for welding fabrication of a golf club head, residual clamping force is absorbed by a resilient cushion unit between the first stroke unit 41 and the third clamping part 42 because of the first stroke unit 41 driving the third clamping part 42 to move toward the first fixing support 2 and grasp the golf club head 6 in the V-shaped groove 221 of the first clamping part 22 as well as in the V-shaped groove 421 of the third clamping part 42; moreover, residual clamping force is also absorbed by the resilient cushions 33 between the second clamping part 31 and the second fixing support 3 when the second stroke unit 51 drives the fourth clamping part 52 to move toward the second fixing support 4 and grasp the golf club head 6 between the second clamping part 31 and the fourth clamping part 52. As such, the golf club head 6 is free from surface abrasion. A surface of the golf club head 6, which relies on adjustable lengths of the fastening parts 522 forming a triangular arrangement on the fourth clamping part 52, will contact the corresponding fourth clamping part 52; a reverse surface of the golf club head 6, which relies on the resilient cushions 33 on the second clamping parts 31 adapted to a cambered surface, will contact the three corresponding second clamping parts 31 by means of the three resilient cushions 33 for good stability.

In a fixture for welding fabrication of a golf club head, the third clamping part 42 (the fourth clamping part 52) driven by the first stroke unit 41 (the second stroke unit 51) has a limited stroke. Accordingly, a fixture for welding fabrication of a golf club head can be further applied to various golf club heads distinct from one another in size because a distance between the first moveable support 4 and the first fixing support 2 and a distance between the second moveable support 5 and the second fixing support 3 are adjusted by the first displacement structure 43 and the second displacement structure 532, respectively.

It can be seen from above descriptions that a technically innovative fixture for welding fabrication of a golf club head with effects and advantages over conventional fixtures for welding golf clubs meets patentability including novelty and non-obviousness.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A fixture for welding fabrication of a golf club head, comprising:
a platform;
a first fixing support installed on the platform and comprising a first clamping part;
a second fixing support installed on the platform, being adjacent to the first fixing support, and comprising at least a second clamping part;
a first moveable support installed on the platform, corresponding to the first fixing support, and comprising a third clamping part and a first stroke unit wherein the third clamping part and the first clamping part are opposite to each other;
a second moveable support installed on the platform, corresponding to the second fixing support, and comprising a fourth clamping part and a second stroke unit wherein the fourth clamping part and the second clamping part are opposite to each other.

2. A fixture for welding fabrication of a golf club head according to claim 1 further comprises a fifth clamping part installed on the platform and among the first fixing support, the second fixing support, the first moveable support and the second moveable support.

3. A fixture for welding fabrication of a golf club head according to claim 2 wherein the fifth clamping part is an elongate component on which a V-shaped groove extending lengthwise is opened.

4. A fixture for welding fabrication of a golf club head according to claim 1 wherein the first fixing support, the second fixing support, the first moveable support and the second moveable support are perpendicular to the platform.

5. A fixture for welding fabrication of a golf club head according to claim 1 wherein the first stroke unit and the second stroke unit are used in driving the third clamping part to move toward the first fixing support and driving the fourth clamping part to move toward the second fixing support.

6. A fixture for welding fabrication of a golf club head according to claim 1 wherein the first stroke unit and the third clamping part are provided with a resilient cushion unit in between.

7. A fixture for welding fabrication of a golf club head according to claim 1 wherein the first clamping part and the third clamping part comprise a V-shaped groove, respectively.

8. A fixture for welding fabrication of a golf club head according to claim 1 wherein the second clamping part is provided with a contacting part and a resilient cushion between the contacting part and the second fixing support.

9. A fixture for welding fabrication of a golf club head according to claim 1 wherein the first moveable support is provided with a first displacement structure by which the first moveable support is adjusted in distance between the first moveable support and the first fixing support and the second moveable support is provided with a second displacement structure by which the second moveable support is adjusted in distance between the second moveable support and the second fixing support.

10. A fixture for welding fabrication of a golf club head according to claim 1 wherein the first fixing support comprises an adjustable structure which has a transverse displacement slot and a sliding component held and shifted along the displacement slot and coupled with the first clamping part.

11. A fixture for welding fabrication of a golf club head according to claim 1 wherein the fourth clamping part comprises a bottom panel and three fastening parts protruding from the bottom panel, adjusted in length, and forming a triangular arrangement.

12. A fixture for welding fabrication of a golf club head according to claim 1 wherein the second fixing support comprises three second clamping parts which form a triangular arrangement.
